(19) United States
(12) Patent Application Publication
(10) Pub. No.: US 2012/0211599 A1
(43) Pub. Date: Aug. 23, 2012

(54) FLOW-MODIFYING FORMATION FOR AIRCRAFT WING

(75) Inventors: Romuald MORVANT, TAMWORTH (GB); Kevin M. BRITCHFORD, BELPER (GB)

(73) Assignee: ROLLS-ROYCE PLC, LONDON (GB)

(21) Appl. No.: 13/357,024

(22) Filed: Jan. 24, 2012

(30) Foreign Application Priority Data
Feb. 21, 2011 (GB) 1102911.3

(51) Int. Cl. B64C 23/00

(52) U.S. Cl. 244/1 N

(57) ABSTRACT

An aircraft wing has an engine attachment position at which a gas turbine engine is attached beneath the wing, in use the engine ejecting a propulsive gas jet with a jet shear layer being formed between the gas jet and the surrounding air. The aircraft wing further has one or more elongate, flow-modifying formations protruding from the underside of the wing. The length direction of the or each formation is along the fore and aft direction of the wing with the trailing edge of the formation being rearward of the trailing edge of the wing. The flow-modifying formations can be arranged such that they interact with the jet shear layer to reduce noise generated by the interaction of the jet shear layer and the wing. They can also be arranged to block, attenuate and/or to scatter the noise reflected by the wing.

The present invention relates to an aircraft wing having one or more flow-modifying formations which can reduce noise generated by the interaction of a jet shear layer and the wing. Additionally or alternatively, they can be arranged to block, attenuate and/or to scatter noise reflected by the wing.

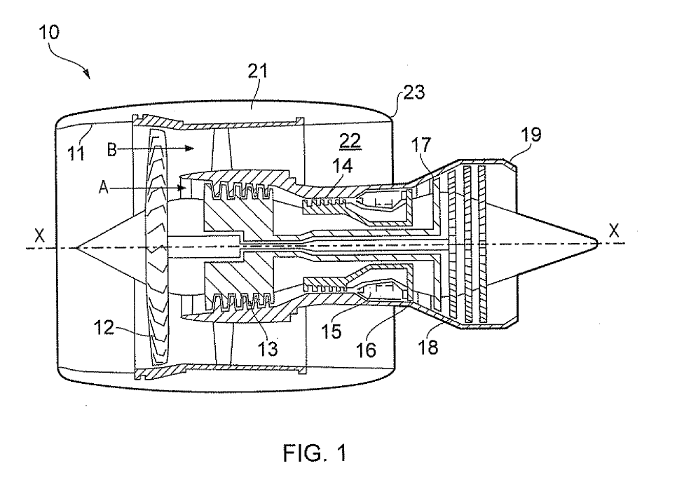

With reference to FIG. 1, a ducted fan gas turbine engine generally indicated at 10 has a principal and rotational axis X-X. The engine comprises, in axial flow series, an air intake 11, a propulsive fan 12, an intermediate pressure compressor 13, a high-pressure compressor 14, combustion equipment 15, a high-pressure turbine 16, and intermediate pressure turbine 17, a low-pressure turbine 18 and a core engine exhaust nozzle 19. A fan nacelle 21 generally surrounds the engine 10 and defines the intake 11, a bypass duct 22 and a bypass exhaust nozzle 23.

The gas turbine engine 10 works in a conventional manner so that air entering the intake 11 is accelerated by the fan 12 to produce two air flows: a first air flow A into the intermediate pressure compressor 14 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate pressure compressors 14, 13 and the fan 12 by suitable interconnecting shafts.

Aircraft noise is a major problem in the aircraft industry. Aircraft manufacturers are under continual pressure to reduce the amount of noise produced by aircraft, particularly during takeoff and landing. Significant noise can be caused by aircraft gas turbine engines. In particular, the downstream mixing of the gas jet exiting from the bypass and core sections of such an engine can generate jet noise.

The interaction of the gas jet emitted by the engine and the surrounding air produces a jet shear layer. In close-coupled engine-wing configurations, this jet shear layer can interact with the wing trailing edge to generate additional noise. Although the noise mechanisms are not fully understood, it is apparent that the radiated noise from the interaction of the shear layer and the trailing edge is highly correlated with the strength of the shear layer.

Accordingly, it is known to serrate engine nozzle exits and to provide vortex-generating devices in engine nacelles in order to change the physical characteristics of the shear layer. However nozzle serrations can be problematic to configure and usually impose performance penalties, while vortex generators can be associated with flow detachment along the fairing of the pylon which attaches the engine to the wing.

An object of the present invention is to exert control on the jet shear layer at the trailing edge of a wing with an aim of reducing noise generated by the interaction of the shear layer with the trailing edge.

Thus the present invention provides an aircraft wing having:

an engine attachment position at which a gas turbine engine is attached beneath the wing, in use the engine ejecting a propulsive gas jet with a jet shear layer being formed between the gas jet and the surrounding air, and

one or more elongate, flow-modifying formations protruding from the underside of the wing, the length direction of the or each formation being along the fore and aft direction of the wing with the trailing edge of the formation being rearward of the trailing edge of the wing.

The pylon may have any one or, to the extent that they are compatible, any combination of the following optional features.

The flow-modifying formations are preferably arranged such that they interact with the jet shear layer to reduce noise generated by the interaction of the jet shear layer and the wing.

Additionally or alternatively, the flow-modifying formations may be arranged to block, attenuate and/or to scatter noise reflected by the wing.

Typically, the flow-modifying formations do not house actuating mechanisms for actuating wing flaps, although, as the trailing edge of the wing may include the trailing edge of such a flap, a formation can be positioned to be rearward of the trailing edge of the flap where beneficial noise reductions can be obtained. A conventional flap-track fairing housing a wing flap actuating mechanism may protrude from the underside of a wing, but such a fairing is generally spaced away from the engine to avoid interaction with the propulsive gas jet. The flow-modifying formations, on the other hand, are typically located proximate the engine and can be substantially smaller than flap-track fairings. However, the flow-modifying formations may be movably deployable themselves. This can help to avoid aerodynamic penalties when the formations are not needed.

The or each flow-modifying formation may be configured to promote particular interactions with the shear layer. Thus, the or each flow-modifying formation may have an undulating trailing edge. The or each flow-modifying formation may have opposing lateral side surfaces which are outwardly concave and converge together towards the trailing edge of the formation. The or each flow-modifying formation may have opposing upper and lower surfaces which are outwardly concave and converge together towards the trailing edge of the formation. The preceding configurations can all be used (separately or in combination) to promote mixing of the flow on opposite sides of the formation, with an aim of weakening or deflecting the shear layer and/or of scattering the noise generated at the trailing-edge of the wing or flap.

Alternatively or additionally, the or each flow-modifying formation can have a plurality of air holes in the external surface thereof for blowing air outwardly from the formation. The blow air can also be used to weaken or deflect the shear layer.

When the wing has a plurality of the flow-modifying formations, these can be at different lateral spacings from the engine attachment position. The distance by which a formation protrudes from the underside of the wing can then increase with lateral spacing of the formation from the engine attachment position. The increased protrusion at greater spacings can help to reduce the distance between a formation and the shear layer and also improve the ability of the formation to block or scatter engine or jet noise.

The surface of the or each flow-modifying formation facing the engine can be covered with a noise attenuation means, for example an acoustic liner, to reduce noise reflected by the wing. This can contribute to a reduction of the overall noise at certification conditions.

Typically the wing has a pylon projecting from the underside of the wing at the attachment position to connect the engine to the wing. A flow-modifying formation can then be located directly behind the pylon. Additionally or alternatively, one or more flow-modifying formations can be laterally spaced from the centre line of the pylon.

The maximum protrusion height of the or each flow-modifying formation can be up to ½ of the shortest distance between the wing trailing edge and the lip of a core exhaust nozzle of the engine. The maximum height can prevent the aerodynamic penalty associated with the formation from becoming excessive. The maximum lateral spacing of the or each formation from a position on the wing directly above the engine centre line can be the radius of the propulsive gas jet at the trailing edge of the wing. At greater lateral spacings, the formations tend to be too far from the gas jet to effectively interact with the shear layer or block or scatter noise.

Embodiments of the invention will now be described by way of example with reference to the accompanying drawings in which:

FIG. 1 shows a longitudinal cross-section through a ducted fan gas turbine engine;

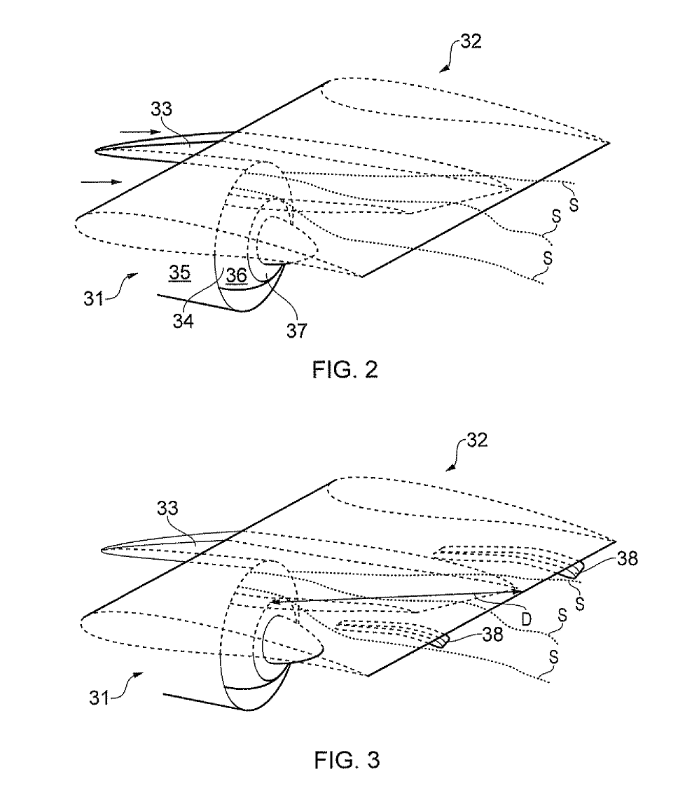

FIG. 2 shows schematically a gas turbine engine attached to the underside of an aircraft wing by a pylon;

FIG. 3 shows schematically another gas turbine engine attached to the underside of an aircraft wing by a pylon;

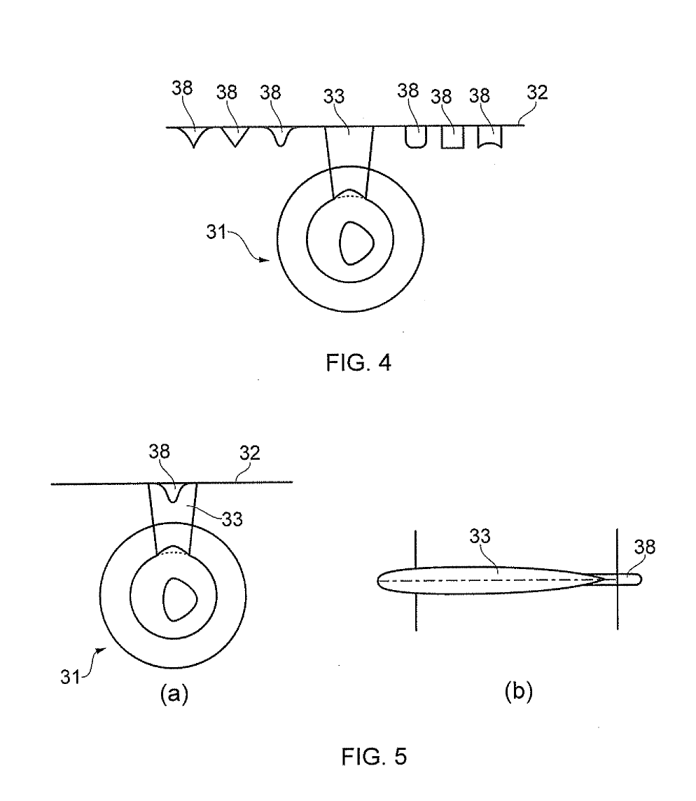

FIG. 4 shows schematically transverse cross-sections through a variety of possible flow-modifying formations protruding from the underside of a wing;

FIG. 5 shows schematically (a) a transverse cross-sections through another flow-modifying formation protruding from the underside of a wing and (b) a sectional view from above of the formation and associated pylon;

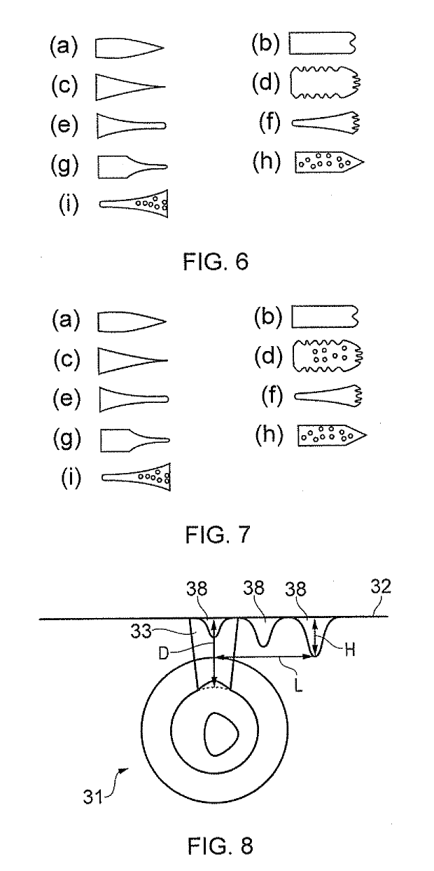

FIGS. 6(a) to (i) show respective schematic side views of the end portions of a number flow-modifying formations, the end portions projecting rearwardly from the trailing edge of the wing, and the trailing edge of the respective end portion being to the right;

FIGS. 7(a) to (i) show respective schematic top views of the end portions of a number flow-modifying formations, the trailing edge of the respective end portion again being to the right; and

FIG. 8 shows schematically a transverse cross-section through a plurality of flow-modifying formations on the underside of a wing.

In the following detailed description, corresponding features in different figures share the same reference numbers.

FIG. 2 shows schematically a gas turbine engine 31 attached to the underside of an aircraft wing 32 by a pylon 33. The engine has an annular bypass duct 34 defined between a fan nacelle 35 and a core fairing 36 for a flow of bypass air. Exhaust gas from the core generator of the engine exits the engine exhaust nozzle 37. The bypass air and surrounding air form a propulsive gas jet which generates a jet shear layer with the surrounding air. The approximate position of the shear layer adjacent the wing is indicated by lines S.

FIG. 3 shows schematically another gas turbine engine 31 attached to the underside of an aircraft wing 32 by a pylon 33. In this case, however, the wing has flow-modifying formations 38 protruding from the underside of the wing. The formations are elongate structures which extend in their length direction along the fore and aft direction of the wing. The trailing edges of the formations are rearward of the trailing edge of the wing.

Due to the proximity of the shear layer S, noise-producing turbulence interacts with the trailing edge of the wing. The formations 38 are arranged such that they interact directly or indirectly with the shear layer to change the turbulence, e.g. by deflecting and weakening the shear layer away from the wing trailing edge. This modification of the shear layer can thus lead to noise reduction.

More generally, the formations 38 locally affect the aerodynamics below the trailing-edge of the wing, which can lead to a change in the jet-wing interaction noise for those parts of the wing above the formations.

In addition, the formations 38 can scatter noise at the trailing edge of the wing, leading to a reduction in perceived noise through e.g. changed noise directivity and/or reduced noise levels. Such noise can, for example, emanate from the engine or from the propulsive gas jet to impinge on the trailing edge. FIG. 4 shows schematically transverse cross-sections through a variety of possible flow-modifying formations. The different cross-sectional shapes of the formations can provide different noise scattering responses, and thus the choice of a particular shape can be made depending on the response required. In FIG. 4, the formations are shown spaced laterally from the centre line of the attachment pylon 33 of the engine 31. However, as shown in FIGS. 5(a) and (b), a formation can also be located directly behind the pylon.

The trailing edge end portion of the flow-modifying formation generally has the most impact on the jet shear layer and noise. Possible shapes for this end portion are shown in FIGS. 6(a) to (i) which are schematic side views of the end portions (i.e. the portions which project beyond the wing trailing edge) of flow-modifying formations, and in FIGS. 7(a) to (i) which are schematic top views of the end portions of flow-modifying formations, in both FIGS. 6 and 7 the trailing edge of the respective end portion being to the right. Shapes which can be particularly effective are those shown in FIGS. 6(e) and (g) and FIGS. 7(e) and (g) in which opposing lateral side surfaces (FIGS. 6(e) and (g)) and/or opposing top and bottom surfaces (FIGS. 7(e) and (g)) are outwardly concave and converge together towards the trailing edge of the formation. Such configurations encourage mixing of the flow on either side of the opposing concave surfaces, which can help to weaken the contribution of the jet shear layer to noise generation. Other shapes which can be particularly effective are those shown in FIGS. 6(b), (d) and (f) and FIGS. 7(b), (d) and (f) in which the trailing edge of the formation is undulated. Such undulations can similarly encourage mixing of the flow on either side of the trailing edge and can be effective at noise scattering.

Another option is to blow air outwardly from the flow-modifying formation to modify the jet shear layer. For example, as shown in FIGS. 6(h) and (i) and FIGS. 7(d) and (h), the end portions may have air holes in the external surface thereof through which air can be ejected to deflect and/or to weaken the shear layer. The direction of the ejected air can be adjusted to reduce any drag penalty caused by its presence.

For flow-modifying formations which are mainly intended to deflect and/or to weaken the shear layer, a location directly behind or close to the attachment pylon is generally preferred, as the shear layer at these locations is typically closer to the wing. On the other hand, flow-modifying formations which are mainly intended to block, attenuate and/or scatter noise reflected by the wing may have a more distant spacing from the attachment pylon. For example, FIG. 8 shows schematically a transverse cross-section through a plurality of flow-modifying formations 38 on the underside of a wing 32. The flow-modifying formations are at different lateral spacings from the pylon 33, and the distance by which a formation protrudes from the underside of the wing increases with lateral spacing of the formation from the pylon. The more distant formation mainly has a noise blocking/scattering function, which requires the increased protrusion. The formation may be covered with acoustic liners to attenuate the noise reflecting on the wing.

Typically, the maximum protrusion height H of a flow-modifying formation is up to ½ of the shortest distance D (indicated in FIGS. 3 and 8) between the wing trailing edge and the lip of the core engine exhaust nozzle. The maximum lateral spacing L of a formation from the position on the wing directly above the engine centre line is typically the radius of the propulsive gas jet at the trailing edge of the wing, noting that the jet tends to expand on ejection from the engine, hence spacing L is shown greater than the radius of the engine 31 in FIG. 8.

As the flow-modifying formations may exact an aerodynamic penalty, the formations can be movably deployable, e.g. so that their protrusion from the wing and/or their rearward projection from the trailing edge of the wing can be reduced or eliminated when they are not needed.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. An aircraft wing having:
an engine attachment position at which a gas turbine engine is attached beneath the wing, in use the engine ejecting a propulsive gas jet with a jet shear layer being formed between the gas jet and the surrounding air, and
one or more elongate, flow-modifying formations protruding from the underside of the wing, the length direction of the or each formation being along the fore and aft direction of the wing with the trailing edge of the formation being rearward of the trailing edge of the wing; wherein the flow-modifying formations are arranged such that they interact with the jet shear layer to reduce noise generated by the interaction of the jet shear layer and the wing.

2. An aircraft wing according to claim 1, wherein the flow-modifying formations are arranged to block, attenuate and/or to scatter noise reflected by the wing.

3. An aircraft wing according to claim I, wherein the or each flow-modifying formation is movably deployable.

4. An aircraft wing according to claim 1, wherein the or each flow-modifying formation has an undulating trailing edge.

5. An aircraft wing according to claim 1, wherein the or each flow-modifying formation has opposing lateral side surfaces which are outwardly concave and converge together towards the trailing edge of the formation.

6. An aircraft wing according to claim 1, wherein the or each flow-modifying formation has opposing upper and lower surfaces which are outwardly concave and converge together towards the trailing edge of the formation.

7. An aircraft wing according to claim 1, wherein the or each flow-modifying formation has a plurality of air holes in the external surface thereof for blowing air outwardly from the formation.

8. An aircraft wing according to claim 1, having a plurality of the flow-modifying formations at different lateral spacings from the engine attachment position, the distance by which a formation protrudes from the underside of the wing increasing with lateral spacing of the formation from the engine attachment position.

9. An aircraft wing according to claim 1, wherein a pylon projects from the underside of the wing at the attachment position to connect the engine to the wing, a flow-modifying formation being directly behind the pylon.

10. An aircraft wing according to claim 1, wherein a pylon projects from the underside of the wing at the attachment position to connect the engine to the wing, one or more flow-modifying formation being laterally spaced from the centre line of the pylon.

11. An aircraft wing according to claim 1, wherein the maximum protrusion height of the or each flow-modifying formation is up to ½ of the shortest distance between the wing trailing edge and the lip of a core exhaust nozzle of the engine.

12. An aircraft wing according to claim 1, wherein the maximum lateral spacing of the or each formation from a position on the wing directly above the engine centre line is typically the radius of the propulsive gas jet at the trailing edge of the wing.
